(19) United States
(12) Patent Application Publication
(10) Pub. No.: US 2018/0184427 A1
(43) Pub. Date: Jun. 28, 2018

(54) METHOD SYSTEM AND APPARATUS FOR DYNAMIC WAKEUP INTERVAL IN NEIGHBOR AWARENESS NETWORKING CLUSTER

(71) Applicant: Intel IP Corporation, Santa Clara, CA (US)

(72) Inventors: Po-Kai Huang, Santa Clara, CA (US); Dave Cavalcanti, Beaverton, OR (US); Emily H. Qi, Gig Harbor, WA (US)

(73) Assignee: Intel IP Corporation, Santa Clara, CA (US)

(21) Appl. No.: 15/389,922

(22) Filed: Dec. 23, 2016

(51) Int. Cl. H04W 72/04; H04W 76/04

(52) U.S. Cl. CPC H04W 72/0453; H04W 76/046

(57) ABSTRACT

The disclosure generally relates to a method, system and apparatus to communicate in a neighbor awareness network (NAN) cluster. In an exemplary embodiment, the disclosure provides dynamic wakeup frequency in one or more mobile devices in a NAN cluster of mobile devices. The dynamic wakeup frequency may include additional device awake times in between consecutive NAN discovery windows (DWs). The additional awake periods may be prompted by a layer higher than the NAN/MAC layer. The additional awake periods may be prompted by the NAN/MAC layer itself in response to observing a larger volume of messages exchanged between the mobile device and other devices in the NAN cluster.

### BACKGROUND

### Field

The disclosure relates to a method, system and apparatus to communicate in a neighbor awareness network (NAN) cluster. Specifically, the disclosure relates to providing dynamic wakeup frequency in one or more mobile devices in a NAN cluster of mobile devices.

### Description of Related Art

Awareness networking enables wireless devices to perform device/service discovery in their proximity Awareness networking includes forming a cluster for devices proximal to each other. One such example is the Network Awareness Neighboring (NAN) protocol. Devices in the same NAN cluster follow the same time schedule through one or more discovery windows (DWs) to facilitate cluster formation and/or to achieve low power operation. Such clusters are particularly useful for device-to-device (D2D) communication.

The recent growth of IoT devices has made it clear that mesh capability among IoT devices is necessary for expanding D2D applications. The IoT technology depends on the NAN protocol to further D2D discovery and communication. While the NAN protocol provides periodic DWs for devices to discover each other, to conserve energy, each device sleeps between consecutive DWs. This implies that a NAN-capable device does not wake up continuously. In fact, a NAN device under discovery mode only wakes up during DW. Each DW has a duration of 16 TU followed by a sleep period. The DW and the sleep period last 512 TU; the process repeats after the sleep period. The NAN devices remain idle during the sleep periods.

Conventional mesh protocol does not allow the application layer or any other higher layer to awake the NAN layer. Consequently, each application must await the subsequent DW to communicate with other devices. A significant time is lost during the idle periods between DWs.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 schematically illustrates a conventional Open System Interconnection (OSI) abstraction;

FIG. 2 schematically illustrates the discovery window timeline of the NAN protocol;

FIG. 3 is a schematic block diagram illustration of a system, in accordance with some embodiments of the disclosure;

FIG. 4 illustrates an exemplary process for implementing an embodiment of the disclosure;

FIG. 5 shows an exemplary device extension capability attribute format; and

FIG. 6 schematically illustrates a timeline for augmented awake period according to one embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i. e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like. Some demonstrative embodiments are described herein with respect to WiFi communication. However, other embodiments may be implemented with respect to any other communication scheme, network, standard and/or protocol.

As discussed, the conventional NAN layer does not support transmission of control messages with frequency higher than once every 512 TU (i.e., beyond the span of DW periods). The NAN layer also lacks mechanism to enable devices to detect and adapt their coordinated wake up schedule/DWs to match the required frequency for exchanging control messages from the routing protocol or from the higher layer applications. To address these and other shortcomings, an embodiment of the disclosure provides method, system and apparatus to provide adaptive frequencies for routing control transmission over the NAN layer.

In an exemplary embodiment of the disclosure, one or more upper layers provide wakeup pattern indication to the NAN layer to awaken the device at intervals between two consecutive DWs. Thus, the device may be awakened at one or more indication slots between two consecutive DWs. In a conventional NAN application, a higher layer may instruct the NAN layer to comply with mandatory wake-ups only at the designated DW time slots. This occurs once every 512 TUs. According to certain embodiments of the disclosure, additional indication slots are provided to awaken the NAN layer frequently (beyond once every 512 TUs) to meet the higher layer applications' needs. In another embodiment, the disclosure relates to an autonomous NAN layer capable of increasing its wakeup frequency (and duration) in response to increasing message rate in a busy application environment.

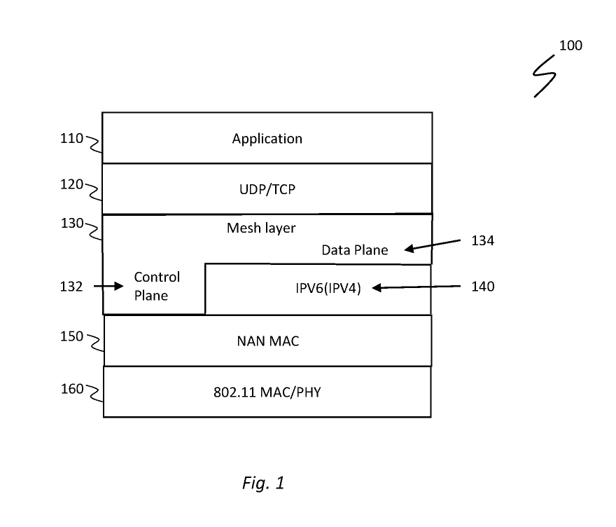

FIG. 1 schematically illustrates a conventional Open System Interconnection (OSI) abstraction. Stack 100 of FIG. 1 may run on any device configured for communication with other devices. FIG. 1 includes application layer 110, UDP/TCP layer 120, Mesh layer 130 and MAC/PHY layer 160. Application layer 110 may support any application which may engage in communication with the application layer of other devices. UDP/TCP layer 120 supports the transport layer. Mesh connectivity layer 130 (MCL) allows the device user to connect to a wireless mesh network that uses Wi-Fi or WiMax. Two types of data are associated with MCL 130, Control Plane 132 and Data Plane 134. Control plane 132 communicates control information which may include availability and broadcast time. Data Plane 134 communicates MCL data. Instructions from upper layers are communicated to the lower layers through interface signaling.

NAN (or NAN/MAC) layer 150 is a D2D protocol developed in layer 150 and built on the existing IEEE 802.11 Standard MAC/PHY framework 160. NAN layer 150 enables device discovery and data transmission between peer devices. To enable mesh capability over NAN, it is possible to utilize the existing developed Mesh protocol in the Mesh layer 130 to connect with the NAN MAC layer 150. Specifically, the mesh functionality may be viewed as a service in NAN layer 150 such that Mesh layer 130 can instruct NAN MAC layer 150 to publish or subscribe the mesh/routing service to build mesh capability and/or routes.

A core component of Mesh layer 130 is the exchange of routing control or neighbor discover messages. Such control messages are exchanged to verify the links between neighboring devices and to create/update routing tables. The routing protocols also control the frequency of transmitting control messages to update mesh network topology. A basic assumption in conventional mesh routing protocols is that routers (or relay nodes) are always awake and listening to the channel. However, the NAN protocol has power saving features that does not wakeup continuously.

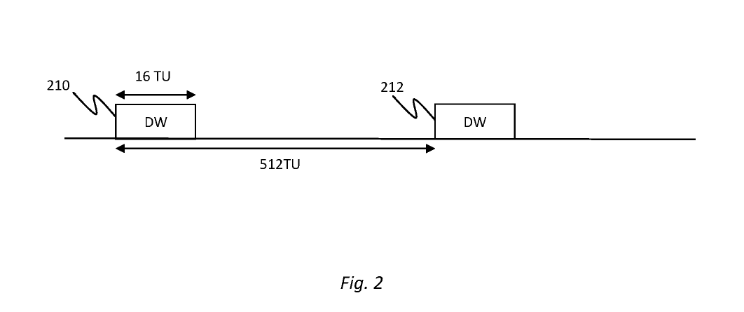

FIG. 2 schematically illustrates DW timeline in NAN protocol. During DW 210 the NAN device is awake and receiving and/or transmitting messages. Each DW has a duration of 16 TU and recurs every 512 TU. One or more discovery beacons are transmitted during each DW. After DW 210, the NAN device goes to sleep to conserve energy. During the balance of the 512 TU duration, the device is in sleep mode until DW 212. That is, a NAN device under discovery mode only wakes up during DW. Further, the higher layers of the NAN protocol (see FIG. 1) have no control over the awake time of the NAN device. Consequently, the NAN layer does not support transmission of control messages with a frequency higher than once every 512 TU. The NAN cluster devices also have no mechanism to detect and adapt their coordinated wakeup schedules (or DWs) to match the required frequency for exchanging control messages from the routing protocol.

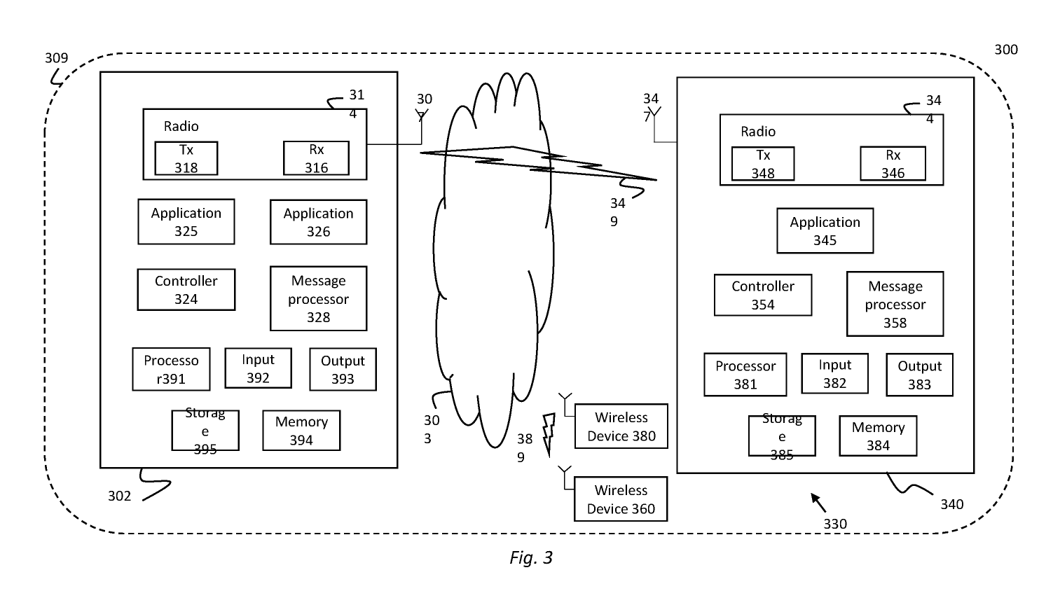

FIG. 3 is a schematic block diagram illustration of a system, in accordance with some embodiments of the disclosure. System 300 of FIG. 3 shows a wireless communication network including one or more wireless communication devices 302, 340, 360 and 380. Wireless communication devices 302, 340, 360 and 380 may include any device capable of mobile communication, for example, a smart device, laptop, phone, or the like. In some embodiments, devices 302, 340, 360 and 380 may include, operate as, and/or perform the functionality of one or more STAs. For example, device 302 may include at least one station (STA) and device 340 may include at least one STA. In some demonstrative embodiments, devices 302, 340, 360 and 380 may include, operate as, or perform the functionality of one or more WLAN, Wi-Fi, BT/BLE STAs. In some demonstrative embodiments, devices 302, 340, 360 and 380 may include, operate as, or perform the functionality of one or more NAN STAs. In some embodiments, devices 302, 340, 360 and 380 may include, operate as, or perform the functionality of one or more location measurement STAs. An STA may include a logical entity that is a singly addressable instance of a medium access control (MAC) and physical layer (PHY) (e.g., layer 160, FIG. 1) interface to the wireless medium (WM). The STA may perform any other additional or alternative functionality. For example, devices 302, 340, 360 and 380 may be configured to operate as, or to perform the functionality of an access point (AP) STA or a non-AP STA. An AP may include an entity that contains a STA and provides access to distribution services through the WM for associated STAs.

In one example, a non-AP STA may comprise an STA that is not contained within an AP. The non-AP STA may perform any other additional or alternative functionality. In one example, device 302 may be configured to operate as, and/or to perform the functionality of an AP, and/or device 340 may be configured to operate as, and/or to perform the functionality of a non-AP STA.

Device 302 may include one or more processor circuitry (“processor”) 391, an input unit 392, an output unit 393, a memory circuitry (“memory”) unit 394, and storage unit 395. Similarly, devices 340, 360 and 380 may include, for example, one or more of processor 381, input unit 382, output unit 383, memory unit 384 and storage unit 385. Memory 382 and storage unit 385 may be combined as one memory module. Devices 302, 340, 360 and 380 may optionally include other suitable hardware components and/or software components. In some embodiments, some or all of the components of one or more of devices 302, 340, 360 and 380 may be enclosed in a common housing or packaging, and may be interconnected or operably associated using one or more wired or wireless links. In other embodiments, components of one or more of devices 302, 340, 360 and 380 may be distributed among multiple or separate devices. In still another embodiment, the components may be integrated into a chipset or a monolithic solid state device.

Processor 391 and processor 381 may comprise a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 391 executes instructions, for example, of an Operating System (OS) of device 302 and/or of one or more suitable applications. Processor 381 executes instructions, for example, of an Operating System (OS) of device 340 and/or of one or more suitable applications.

Input units 392 and 382 may include a keyboard, a keypad, a mouse, a touch-screen, a touch-pad, a track-ball, a stylus, a microphone, or other suitable pointing device or input device. Output units 393 and 383 may include a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

Memory units 394 and 384 may include Random Access Memory (RAM), Read Only Memory (ROM), Dynamic RAM (DRAM), Synchronous DRAM (SD-RAM), flash memory, volatile memory, non-volatile memory, cache memory, buffer, short term memory unit, long term memory unit or other suitable memory units. Storage unit 395 and storage unit 385 may include hard disk drive, floppy disk drive, Compact Disk (CD) drive, CD-ROM drive, DVD drive or other suitable removable or non-removable storage units. Memory units 394 and 395 may store data processed by device 302. Memory units 384 and 385 may store data processed by device 340.

Wireless communication devices 302, 340, 360 and 380 may communicate content, data, information and/or signals via WM 303. In some embodiments, wireless medium 303 may include, for example, a radio channel, a cellular channel, a Global Navigation Satellite System (GNSS) Channel, an RF channel, a Wireless Fidelity (WiFi) channel, an IR channel, a BT channel or the like.

Wireless communication medium 303 may also include a wireless communication channel over a 2.4 Gigahertz (GHz) frequency band, a 5 GHz frequency band, a millimeterWave (mmWave) frequency band, e.g., a 60 GHz frequency band, a Sub 1 Gigahertz (S1G) band, and/or any other frequency band. In some embodiments, devices 302, 340, 360 and 380 may include one or more radios including circuitry and/or logic to perform wireless communication between such devices. For example, device 302 may include at least one radio 314 and device 340 may include at least one radio 344.

Radio 314 may include one or more wireless receivers (Rx) including circuitry and/or logic to receive wireless communication signals, RF signals, frames, blocks, transmission streams, packets, messages, data items, and/or data. By way of example, radio 314 may include at least one receiver 316 and radio 344 may include at least one receiver 346. In some embodiments, radios 314 and 344 may include one or more wireless transmitters (Tx) including circuitry and/or logic to transmit wireless communication signals, RF signals, frames, blocks, transmission streams, packets, messages, data items, and/or data. For example, radio 314 may include at least one transmitter 318 and radio 344 may include at least one transmitter 348. In some embodiments, radios 314 and 344 may be configured to communicate over a 2.4 GHz band, a 5 GHz band, an mmWave band, a SIG band, and/or any other band.

Radios 314 and 344 may include, or may be associated with, one or more antennas 307 and 347, respectively. In one example, device 302 may include a single antenna 307. In another example, device 302 may include two or more antennas 307. Similarly, device 340 may include a single antenna or multiple antennas. Antennas 307 and 347 may include any type of antennas suitable for transmitting and/or receiving wireless communication signals, blocks, frames, transmission streams, packets, messages and/or data. For example, antennas may include any suitable configuration, structure and arrangement of one or more antenna elements, components, units, assemblies and/or arrays. Antennas 307 and/or 347 may include, for example, antennas suitable for directional communication, e.g., using beamforming techniques. Antennas 307 and 347 may include a phased array antenna, a multiple element antenna, a set of switched beam antennas, and/or the like. In some embodiments, antennas 307 and 347 may implement transmit and receive functionalities using separate transmit and receive antenna elements. In some embodiments, antennas 307 and 347 may implement transmit and receive functionalities using integrated transmit/receive elements.

In some embodiments, wireless communication devices 302, 340, 360 and 380 may form, and/or may communicate as part of, a WLAN, WiFi, WiFi Direct (WFD) network or WiFi direct services (WFDS). Further devices 302, 340, 360 and 380 may perform awareness networking communications according to an awareness protocol (e.g., a WiFi aware protocol or any other protocol). In some embodiments, devices 302, 340, 360 and 380 may form or be a part of, NAN network or may perform the functionality of one or more NAN devices. Wireless communication medium 303 may include a direct link, for example, a PTP link (“e.g., a WiFi direct P2P link”) or any other PTP link to enable direct communication between wireless communication devices 302, 340, 360 and 380. In other embodiments, wireless devices 302, 340, 360 and 380 may perform the functionality of WFD P2P devices including functionality of a P2P client device, and/or P2P group Owner (GO) device.

In some demonstrative embodiments, device 102 may execute an application 125 and/or an application 126. In some demonstrative embodiments, device 140 may execute an application 145. In some demonstrative embodiments, devices 102, 140, 160 and/or 180 may be capable of sharing, showing, sending, transferring, printing, outputting, providing, synchronizing, and/or exchanging content, data, and/or information, e.g., between applications and/or services of devices 102, 140, 160 and/or 180 and/or one or more other devices.

Devices 302, 340, 360 and 380 may further one or more controllers (interchangeably, controller circuitry) configured to control one or more functionalities of devices 302, 340, 360 and 380 including awareness networking communications, WiFi Aware NAN communication or any other communication between these devices. For example, device 302 may include controller 324 and device 340 may include controller 354. Each controller may be configured to perform and/or trigger one or more functionalities, communications, operations and/or procedures between wireless communication devices. In some embodiments, controller 324 may include circuitry and/or logic (e.g., one or more processors including circuitry and/or logic), memory circuitry and/or logic, Media-Access Control (MAC) circuitry and/or logic, Physical Layer (PHY) circuitry and/or logic, and/or any other circuitry and/or logic configured to perform the functionality of controller 324. One or more functionalities of the controller may be implemented by logic which may be executed by a machine and/or one or more processors. Each controller may comprise hardware, software or a combination of hardware and software.

In one example, controller 324 may include circuitry and/or logic, for example, one or more processors and/or memory including circuitry and/or logic to cause, trigger or control device 302 to perform one or more operations, communications or functionalities. Similarly, controller 354 may include circuitry and/or logic, for example, one or more processors and/or memory including circuitry and/or logic to cause, trigger or control device 140. Such functionalities may include functionalities of a NAN engine or a NAN discovery engine (DE), for example, to process one or more service queries and/or responses, from applications and/or services on devices 302, 340, 360 and 380. Controllers 324 and 354 may be implemented in software. In an exemplary embodiment, controllers 324 and 354 are implemented in software on processor 391 and 381, respectively.

Optionally, device 302 may also include message processor 328 configured to generate, process and/or access one or messages communicated by device 302. Similarly, optional message processor 358 may be configured to generate one or more messages to be transmitted by device 340.

Message processors 328 and 358 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of message processors 328 and 358. Message processors 328 and 358 may perform one or more functionalities of a NAN MAC configured to generate, process or handle one or more NAN messages including NAN Beacon frames or NAN Service Discovery frames. At least part of the functionality of message processor 328 may be implemented as part of radio 314. The message processors may be implemented in software running on one or more processor circuitries. For example, a part of message processor 328 functionality may be implemented as part of controller 324 or as part of any other element of device 302. In some embodiments, at least part of the functionality of controller 324, radio 314, and/or message processor 328 may be implemented by an integrated circuit, for example, a chip (e.g., a System on Chip (SoC)). Message processor 358 may be implemented similarly.

The wireless communication devices of FIG. 3 may include one or more blocks or entities to perform network awareness functionality. For example, a device may perform the functionality of a NAN device including a NAN MAC and a Discovery Engine. For example, controllers 324 and/or 354 may be configured to perform the functionality of the discovery engine. Message processors 328 and/or 358 may be configured to perform the functionality of the NAN MAC. In another example, the functionality of the NAN MAC and/or the Discovery engine may be performed by any other element and/or entity of the wireless devices. Additionally, devices 302, 340, 360 and 380 may perform a discovery process according to the awareness networking scheme to discover each other and to establish a wireless communication cluster or any other link.

It should be noted that the exemplary embodiments provided herein are described with respect to NAN discovery frames of the NAN discovery scheme. However, in other embodiments, any other discovery scheme and/or discovery frames may be used. In some demonstrative embodiments, the discovery scheme may include a plurality of contention-based discovery windows. Communication during the DWs may be configured to enable time synchronization between STAs 302, 340, 360 and 380 so that STAs can find each other more efficiently during a DW.

Devices 302, 340, 360 and 380 may form one or more NAN clusters in order to publish and/or subscribe for services. A NAN cluster may include an Anchor Master (AM) (also referred to as a “NAN master device” or “anchor device”). The AM may include a NAN device which has the highest rank in the NAN cluster. The NAN data exchange may be reflected by discovery frames which include Publish, Subscribe and/or Follow-Up Service discovery frames (SDF). These frames may include action frames, which may be sent by a device that wishes to publish a service/application, and/or to subscribe to a published service/application at another end.

One of devices 302, 340, 360 and 380 (e.g., device 302) may perform the functionality of an AM. The AM may be configured to transmit one or more beacons. Another device (e.g., device 340) may be configured to receive and process the beacons. Devices 302, 340, 360 and 380 may perform the functionality of NAN devices, (e.g., belonging to a NAN cluster) which may share a common set of NAN parameters, for example, including a common NAN timestamp, and/or a common time period between consecutive DWs. The NAN timestamp may be communicated as part of a NAN beacon frame which may be communicated to the NAN cluster. The NAN timestamp may include a Time Synchronization Function (TSF) value, a cluster TSF value or any other value.

Devices 302, 340, 360 and 380 may be configured to discover one another over a predefined communication channel (i.e., “the social channel”). The social channel may be channel 6 in the 2.4 GHz band. Any other channel may be used as the social channel Thus, devices 302, 340, 360 and 380 may transmit SDFs during the plurality of DWs over the social channel. The NAN AM may advertise the time of the DW during which NAN devices may exchange SDFs. In addition, devices 302, 340, 360 and 380 may transmit discovery frames to discover each other and to enable using the services provided by applications 325 and 326. The discovery frame may be transmitted as a group addressed. A group address may be broadcast or multicast in a discovery frame. The discovery frame may be transmitted as any other type of frame. The discovery frame may not require an acknowledgement frame and the transmitter of the discovery frame may not backoff a transmission of the discovery frame.

The discovery frame transmitted by device 302 during the DW may be configured to enable other devices, or services that are running on other devices, to discover the services on device 302. In some embodiments, devices of system 300 may utilize availability information in the form of an Availability Interval Bitmap and/or Further AM, to allow a device of devices 302, 340, 360 and 380, to advertise its availability in terms of at least one channel and one or more timeslots, during which the device may be available (interchangeably, active or awake) to perform post NAN activities. As described below, in certain embodiments, one or more layers above the NAN MAC layer (150, FIG. 1) instruct this layer to increase awake time beyond the conventional awake time under the NAN protocol. In another embodiment, the NAN layer discerns or determines the need for additional awake time based on the volume of messages send/received by higher layers or applications. For example, controller 324 may monitor activities of message processor 328 and decide to increase the frequency of awaking the NAN layer to accommodate the actual or expected activity level.

Wireless device availability information may be communicated as part of an Availability Attribute. The Availability Attribute may include a 32-bit bitmap for 32 timeslots, where each timeslot is 16 milliseconds (ms or TU) long. Each bit that is not zero may represent a timeslot, during which, a device sending the Availability Attribute is to be awakened and made available to send and receive data. As stated, device 302 may be part of a NAN awareness cluster 309. One or more Availability Attribute may be broadcasted to cluster 309 on regular basis. Devices 302, 340, 360 and/or 380 may be configured to communicate according to a Wi-Fi Aware specification and/or any other awareness networking specification, which may be configured to allow a group of devices to discover other devices/services nearby and/or in close proximity Such discovery may be done using low power. Thus, devices 302, 340, 360 and/or 380 of NAN cluster 309 may synchronize to the same clock. All devices of cluster 309 may converge on a time period and DW channel to facilitate the discovery of services of devices 302, 340, 360 and 380 to achieve low power consumption. In some embodiments, when two devices do not hear each other, each device may announce its schedule in the form of availability information indicating one or more available channels and one or more available time slots, independently. such devices may merge and/or adjust their schedules to save power.

Some embodiments are described below with respect to NAN clusters having x-hop peers, where x=1 (also known as the one-hop devices/peers). Some embodiments are described below with respect to the 1-hop devices. However, such embodiments may be extended to an algorithm that considers resource constraints of the x-hop devices, where x is greater than one.

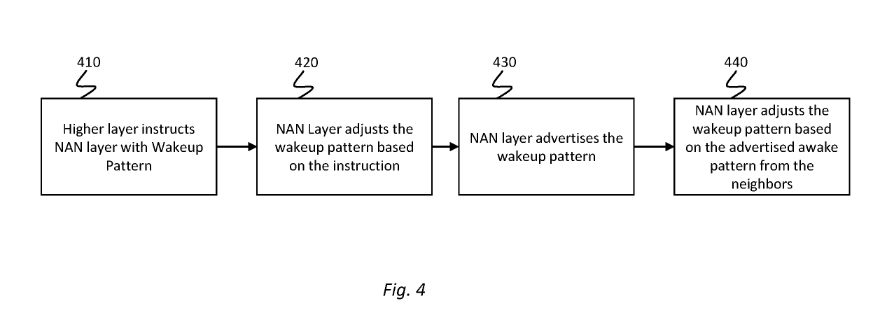

FIG. 4 illustrates an exemplary process for implementing an embodiment of the disclosure. At step 410, the process starts when a higher layer instructs the NAN layer with a new (or subsequent) wakeup pattern. As discussed, the conventional wakeup pattern of a NAN device is only during the DW and it occurs once every 512 TU. Step 410 allows a different wakeup pattern than the conventional wakeup pattern. The new or subsequent wakeup pattern may be more frequent than 512 TU. In one embodiment of the disclosure, step 410 allows a higher layer to instruct wake up interval required for control message. The higher layer may be a Mesh layer, an application layer or any layer higher than the NAN MAC layer as shown in FIG. 1. In an exemplary embodiment, the subsequent wake up interval can be smaller than one DW interval.

In certain embodiments, the signaling may be added in the publish/subscribe method from service/application to NAN layer. That is, the request for publication/subscription may be directed from a higher layer (e.g., an application) to the NAN layer each time the higher layer wishes the NAN layer to be awake for publication/subscription purposes. In another application of the embodiments, the signaling can reuse the current awake DW interval signaling to provide additional indication(s) such as 1/n, where n can be 2, 4, 8, 16, 32. When awake DW interval indicate 1/n, it means that the awake period of the device is equal to 512/n. In certain embodiments, interval signaling may simply indicate awake period(s) which can be equal to 16*n TU, where n is 1, 2, 4, 8, 16, or 32. In another application, interval signaling may be any frequency including frequencies smaller than 16 TU. The NAN layer will then accommodate the requested frequency

In an optional implementation, the higher layer may indicate the current frequency of routing control messages for the routing service. To ensure proper alignment between different devices, the services can align on the awake pattern. That is, a NAN device may follow the 16 TU slot boundary and always awake at the beginning of the slot boundary. Further, the awake pattern may include DW₀, a designated 16 TU slot agreed by NAN device in the same cluster.

At step 420, the NAN layer of the device adjusts its wakeup pattern based on the instruction received from the higher layer. In an exemplary implementation, when the NAN layer (e.g., NAN MAC layer 150, FIG. 1) receives the instructions, the device then starts to follow the awake pattern instructed by the higher layer or it will adjust the awake pattern to accommodate the frequency instructed by the higher layer.

In an alternative embodiment, steps 410 and 420 may be autonomously implemented by the NAN layer and without receiving instructions from a higher layer. Here, the NAN layer adjusts its wakeup frequency based on the control message transmission request(s) received from the higher layer(s). Specifically, the NAN layer observes the frequency of control message transmission request in the past x seconds. Based on the number of requests, the NAN layer adjusts the wakeup pattern for transmitting control messages to accommodate such requests.

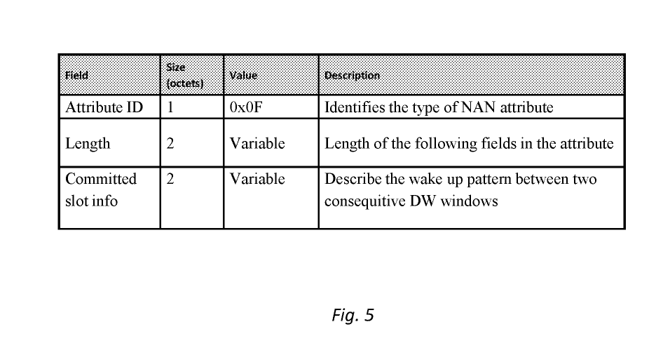

Referring once again to FIG. 4, in step 430 the NAN layer advertises its wakeup pattern to all devices in its NAN cluster to allow the new wakeup interval signaling to be carried in the publish/subscribe message. In one implementation, the signaling may be carried out in an attribute field (see, e.g., FIG. 5) which can then be carried in the publish/subscribe message. In one embodiment, the attribute can be an existing device capability attribute. In another embodiment, the attribute may be a new attribute. For example, the new attribute may be a message broadcast parameters attribute. In still another example, the attribute can be the availability attribute used to indicate further availability window (FAW). FAW is the additional time slot(s) that the device is potentially available or awake to transmit or receive frames.

Step 430 may provide information beyond the new wakeup time. For example, a service may be attached to the awake pattern indicated by the wakeup interval. The service may require connecting all devices using the same application. The application developers may have a fixed awake pattern for the service. As a result, all devices using the same application may communicate with each other based on the fixed awake pattern. Alternatively, or in addition, an indication may be attached to the awake pattern to instruct neighboring devices to follow the same wake up pattern. For example, an awake pattern may be sent along with the service information published in the frame. If a device receives the frame and wishes to follow the service, then the device will follow the received indicated awake pattern.

Step 440 of FIG. 4 relates to the other NAN devices in the cluster. Such neighbor devices receive the NAN layer advertisement from the master device (see step 430, FIG. 4) and decide whether to follow or try to align the advertised awake pattern to receive the publish/subscribe message. In one implementation, a NAN cluster device may have optionally change its wakeup pattern. A NAN neighboring devices can choose to awake if the awaking pattern is related to a service that the neighboring devices may be interested (e.g., routing service). The decision for a neighboring device to follow the awake pattern can be determined by the signaling in the received message.

FIG. 5 shows an exemplary device extension capability attribute (availability attribute) format. The availability attribute can carry out the signaling for changing awake pattern which may be carried in the publish/subscribe message from the NAN layer. The extension capability attribute includes field identification, size, value and description. The field may include attribute ID, length and committed slot information. The size may identify each field's allotted sized in octets. The value indicates the expected value of each field and the description provides an explanation of each field.

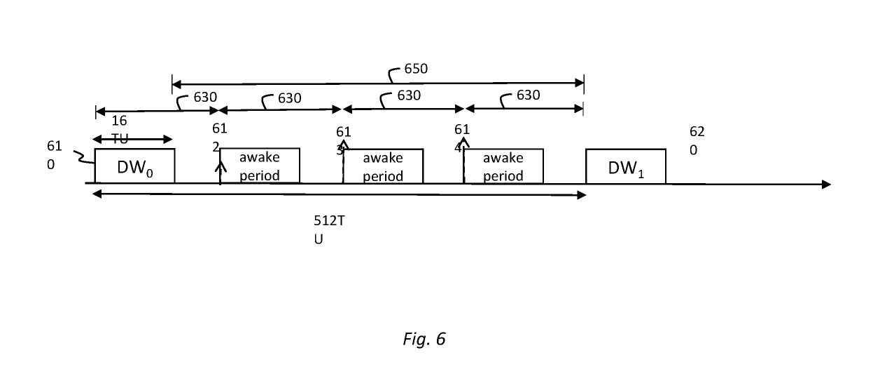

FIG. 6 schematically illustrates a timeline for augmented awake period according to one embodiment of the disclosure. Specifically, FIG. 6 illustrates an exemplary embodiment where the NAN layer is awakened several times in between consecutive DWs. In FIG. 6, a first discovery period begins with DW₀ identified as 610. DW₀ is followed by DW₁, 620. Duration 650 is a period of inactivity and sleep for the mobile device. A combination of DW₀ and the sleep period 650 which follows DW₀ and ends at DW₁ may be considered as a first frequency or pattern. During the first frequency, the mobile device is awake only during DW₀. The span 630 indicates an exemplary augmented wake up frequency (i.e., second frequency pattern or second awake pattern). Each of span 630 periods includes an awake period which starts by an indication slot as illustrated with an arrow. In conventional NAN applications, the time span between DW₀ and DW₁ (i.e., span 650) is unoccupied by any activity as the mobile device is asleep to conserve energy. In the exemplary embodiment of FIG. 6, span 650 includes three wakeup periods which are identified as 612, 613 and 614. The additional awake periods and the first discovery window (DW₀) may be considered as the second frequency of pattern. During the awake periods (612, 613 and 614), the NAN layer may publish/subscribe messages. That is, information may be transmitted on the awake periods indicated by the second frequency. The additional wakeup periods show that the device is awakened by three additional indication slots between DW₀ and DW₁ (the original discovery windows). In FIG. 6, the period between two consecutive wakeup periods of the second frequency awake pattern may be determined as a function of 16*n TU, where n is one of 1, 2, 4, 8, 16 or 32. Moreover, one or more awake pattern indication may follow a 16*n TU timeslot boundary, where n is 1, 2, 4, 8, 16 or 32.

It should be noted that the duration between two consecutive awake period (e.g., awake periods 612 and 613) is smaller than the sleep period between two consecutive DWs (i.e., duration 650). The duration of an awake period (e.g., 612) may be defined according to the desired application or need.

The following examples illustrate non-limiting and exemplary embodiments of the disclosure. Example 1 is directed to an apparatus comprising logic and circuitry configured to cause a mobile device in a Neighbor Awareness Networking (NAN) cluster of devices to: receive instruction to change an awake pattern of the mobile device from a first frequency to a second frequency by inserting one or more indication slots between two consecutive NAN discovery windows (DWs), each indication slot awakening the mobile device at a designated time for an awake period; change the awake pattern of the mobile device to the second frequency, the second frequency having at least one DW and one or more awake periods to correspond to the one or more indication slots; advertise the second frequency to one or more devices of the NAN cluster; and transmit information during at least one awake period reflected by the second frequency.

Example 2 is directed to the apparatus of example 1, wherein the period between two consecutive awake periods is smaller than a duration between two consecutive DWs.

Example 3 is directed to the apparatus of examples 1 or 2, wherein a NAN layer associated with the mobile device transmits one or more control messages to at least one other device in the NAN cluster to follow the second frequency.

Example 4 is directed to the apparatus of any preceding example, wherein the instruction to change the awake pattern is issued from a MESH layer application.

Example 5 is directed to the apparatus of any preceding example, wherein a duration between two consecutive awake periods of the second frequency is determined as a function of 16*n TU, where n is one of 1, 2, 4, 8, 16 or 32.

Example 6 is directed to the apparatus of any preceding example, wherein the one or more indication slots follow a 16*n TU timeslot boundary, where n is 1, 2, 4, 8, 16 or 32.

Example 7 is directed to the apparatus of any preceding example, wherein the logic is implemented at a NAN layer.

Example 8 is directed to the apparatus of any preceding example, wherein each of the devices in the NAN cluster is not more than one hop away from the NAN device.

Example 9 is directed to a tangible machine-readable non-transitory storage medium that contains instructions, which when executed by one or more processors of a mobile device in a Neighbor Awareness Networking (NAN) cluster result in performing operations comprising: receive instruction to change an awake pattern of the mobile device from a first frequency to a second frequency by inserting one or more indication slots between two consecutive NAN discovery windows (DWs), each indication slot awakening the mobile device at a designated time for an awake period; change the awake pattern of the mobile device to the second frequency, the second frequency having at least one DW and one or more awake periods to correspond to the one or more indication slots; advertise the second frequency to one or more devices of the NAN cluster; and transmit information during at least one awake period reflected by the second frequency.

Example 10 is directed to the medium of example 9, wherein the period between two consecutive awake periods is smaller than a duration between two consecutive DWs.

Example 11 is directed to the medium of any of examples 9-10, wherein a NAN layer associated with the mobile device transmits one or more control messages to at least one other device in the NAN cluster to follow the second frequency.

Example 12 is directed to the medium of any of examples 9-11, wherein the instruction to change the awake pattern is issued from a MESH layer application.

Example 13 is directed to the medium of any of examples 9-13, wherein a duration between two consecutive awake periods of the second frequency is determined as a function of 16*n TU, where n is one of 1, 2, 4, 8, 16 or 32.

Example 14 is directed to the medium of any of examples 3-13, wherein the one or more indication slots follow a 16*n TU timeslot boundary, where n is 1, 2, 4, 8, 16 or 32.

Example 15 is directed to the medium of any of examples 9-14, wherein each of the devices in the NAN cluster is not more than one hop away from the NAN device.

Example 16 is directed to an apparatus comprising logic and circuitry configured to cause a mobile device in a Neighbor Awareness Networking (NAN) cluster to: determine whether to change awake pattern of the mobile device from a first frequency to a second frequency as a function of a number of control messages received at the mobile device; change the awake pattern of the mobile device to the second frequency, the second frequency having at least one discovery window (DW) and one or more awake periods between two consecutive NAN DWs; and advertise the second frequency to one or more devices of the NAN cluster; wherein the awake pattern is changed from the first frequency to the second frequency by inserting one or more indication slots between two consecutive NAN DWs, each indication slot awakening the mobile device at a designated time for an awake period.

Example 17 is directed to the apparatus of example 16, wherein a duration between two consecutive awake periods is smaller than a duration between two consecutive DWs.

Example 18 is directed to the apparatus of any of examples 16-17, wherein the mobile device transmits information during at least one awake period to at least one other device in the NAN cluster to change the awake pattern from the first frequency to the second frequency.

Example 19 is directed to the apparatus of any of examples 16-18, wherein the mobile device transmits one or more control messages to the NAN cluster to change awake patterns and wherein the one or more control messages from the mobile device are carried in an attribute of a NAN service discovery frame.

Example 20 is directed to the apparatus of any of examples 16-19, wherein a duration between two consecutive awake periods of the second frequency is determined as a function of 16*n TU, where n is one of 1, 2, 4, 8, 16 or 32.

Example 21 is directed to the apparatus of any of examples 16-20, wherein the one or more indication slots follow a 16*n TU timeslot boundary, where n is 1, 2, 4, 8, 16 or 32.

Example 22 is directed to a tangible machine-readable non-transitory storage medium that contains instructions, which when executed by one or more processors of a mobile device in a Neighbor Awareness Networking (NAN) Cluster, result in performing operations comprising: determine whether to change awake pattern of the mobile device from a first frequency to a second frequency as a function of a number of control messages received at the mobile device; change the awake pattern of the mobile device to the second frequency, the second frequency having at least one discovery window (DW) and one or more awake periods between two consecutive NAN DWs; and advertise the second frequency to one or more devices of the NAN cluster; wherein the awake pattern is changed from the first frequency to the second frequency by inserting one or more indication slots between two consecutive NAN DWs, each indication slot awakening the mobile device at a designated time for an awake period.

Example 23 is directed to the medium of example 22, wherein a duration between two consecutive awake periods is smaller than a duration between two consecutive DWs.

Example 24 is directed to the medium of any of examples 22-23, wherein the mobile device transmits information during at least one awake period to at least one other device in the NAN cluster to change the awake pattern from the first frequency to the second frequency.

Example 25 is directed to the medium of any of examples 22-24, wherein the mobile device transmits one or more control messages to the NAN cluster to change awake patterns and wherein the one or more control messages from the mobile device are carried in an attribute of a NAN service discovery frame.

Example 26 is directed to the medium of any of examples 22-25, wherein a duration between two consecutive awake periods of the second frequency is determined as a function of 16*n TU, where n is one of 1, 2, 4, 8, 16 or 32.

Example 27 is directed to the medium of any of examples 22-26, wherein the one or more indication slots follow a 16*n TU timeslot boundary, where n is 1, 2, 4, 8, 16 or 32.

Example 28 is directed to the apparatus of any preceding claim further comprising one or more antenna to at least one of receive or transmit communication to one or more of the NAN devices in the cluster.

Example 29 is directed to the apparatus of claim 28, further comprising a front-end radio device in communication with one or more antenna.

Example 30 is directed to a method to cause a mobile device in a Neighbor Awareness Networking (NAN) cluster of devices to change an awake pattern from a first frequency to a second frequency, the method comprising: receiving instruction to change an awake pattern of the mobile device from a first frequency to a second frequency by inserting one or more indication slots between two consecutive NAN discovery windows (DWs), each indication slot awakening the mobile device at a designated time for an awake period; changing the awake pattern of the mobile device to the second frequency, the second frequency having at least one DW and one or more awake periods to correspond to the one or more indication slots; advertising the second frequency to one or more devices of the NAN cluster; and transmitting information during at least one awake period reflected by the second frequency.

Example 31 is directed to the method of example 30, wherein the period between two consecutive awake periods is smaller than a duration between two consecutive DWs.

Example 32 is directed to the method of examples 30-31, wherein a NAN layer associated with the mobile device transmits one or more control messages to at least one other device in the NAN cluster to follow the second frequency.

Example 33 is directed to the method of examples 30-32, wherein the instruction to change the awake pattern is issued from a MESH layer application.

Example 34 is directed to the method of examples 30-33, wherein a duration between two consecutive awake periods of the second frequency is determined as a function of 16*n TU, where n is one of 1, 2, 4, 8, 16 or 32.

Example 35 is directed to the method of examples 30-34, wherein the one or more indication slots follow a 16*n TU timeslot boundary, where n is 1, 2, 4, 8, 16 or 32.

Example 36 is directed to a system comprising: a processor circuitry, a memory circuitry, one or more antenna and a front-end receiver circuitry, wherein the system comprises further logic and circuitry configured to cause a mobile device in a Neighbor Awareness Networking (NAN) cluster of devices to: receive instruction to change an awake pattern of the mobile device from a first frequency to a second frequency by inserting one or more indication slots between two consecutive NAN discovery windows (DWs), each indication slot awakening the mobile device at a designated time for an awake period; change the awake pattern of the mobile device to the second frequency, the second frequency having at least one DW and one or more awake periods to correspond to the one or more indication slots; advertise the second frequency to one or more devices of the NAN cluster; and transmit information during at least one awake period reflected by the second frequency.

While the principles of the disclosure have been illustrated in relation to the exemplary embodiments shown herein, the principles of the disclosure are not limited thereto and include any modification, variation or permutation thereof.

What is claimed is:

1. An apparatus comprising logic and circuitry configured to cause a mobile device in a Neighbor Awareness Networking (NAN) cluster of devices to:
receive instruction to change an awake pattern of the mobile device from a first frequency to a second frequency by inserting one or more indication slots between two consecutive NAN discovery windows (DWs), each indication slot awakening the mobile device at a designated time for an awake period;
change the awake pattern of the mobile device to the second frequency, the second frequency having at least one DW and one or more awake periods to correspond to the one or more indication slots;
advertise the second frequency to one or more devices of the NAN cluster; and
transmit information during at least one awake period reflected by the second frequency.

2. The apparatus of claim 1, wherein the period between two consecutive awake periods is smaller than a duration between two consecutive DWs.

3. The apparatus of claim 1, wherein a NAN layer associated with the mobile device transmits one or more control messages to at least one other device in the NAN cluster to follow the second frequency.

4. The apparatus of claim 1, wherein the instruction to change the awake pattern is issued from a MESH layer application.

5. The apparatus of claim 1, wherein a duration between two consecutive awake periods of the second frequency is determined as a function of 16*n TU, where n is one of 1, 2, 4, 8, 16 or 32.

6. The apparatus of claim 1, wherein the one or more indication slots follow a 16*n TU timeslot boundary, where n is 1, 2, 4, 8, 16 or 32.

7. The apparatus of claim 1, wherein the logic is implemented at a NAN layer.

8. The apparatus of claim 1, wherein each of the devices in the NAN cluster is not more than one hop away from the NAN device.

9. A tangible machine-readable non-transitory storage medium that contains instructions, which when executed by one or more processors of a mobile device in a Neighbor Awareness Networking (NAN) cluster result in performing operations comprising:
receive instruction to change an awake pattern of the mobile device from a first frequency to a second frequency by inserting one or more indication slots between two consecutive NAN discovery windows (DWs), each indication slot awakening the mobile device at a designated time for an awake period;
change the awake pattern of the mobile device to the second frequency, the second frequency having at least one DW and one or more awake periods to correspond to the one or more indication slots;
advertise the second frequency to one or more devices of the NAN cluster; and
transmit information during at least one awake period reflected by the second frequency.

10. The medium of claim 9, wherein the period between two consecutive awake periods is smaller than a duration between two consecutive DWs.

11. The medium of claim 9, wherein a NAN layer associated with the mobile device transmits one or more control messages to at least one other device in the NAN cluster to follow the second frequency.

12. The medium of claim 9, wherein the instruction to change the awake pattern is issued from a MESH layer application.

13. The medium of claim 9, wherein a duration between two consecutive awake periods of the second frequency is determined as a function of 16*n TU, where n is one of 1, 2, 4, 8, 16 or 32.

14. The medium of claim 9, wherein the one or more indication slots follow a 16*n TU timeslot boundary, where n is 1, 2, 4, 8, 16 or 32.

15. The medium of claim 9, wherein each of the devices in the NAN cluster is not more than one hop away from the NAN device.

16. An apparatus comprising logic and circuitry configured to cause a mobile device in a Neighbor Awareness Networking (NAN) cluster to:
determine whether to change awake pattern of the mobile device from a first frequency to a second frequency as a function of a number of control messages received at the mobile device;
change the awake pattern of the mobile device to the second frequency, the second frequency having at least one discovery window (DW) and one or more awake periods between two consecutive NAN DWs; and
advertise the second frequency to one or more devices of the NAN cluster;
wherein the awake pattern is changed from the first frequency to the second frequency by inserting one or more indication slots between two consecutive NAN DWs, each indication slot awakening the mobile device at a designated time for an awake period.

17. The apparatus of claim 16, wherein a duration between two consecutive awake periods is smaller than a duration between two consecutive DWs.

18. The apparatus of claim 16, wherein the mobile device transmits information during at least one awake period to at least one other device in the NAN cluster to change the awake pattern from the first frequency to the second frequency.

19. The apparatus of claim 18, wherein the mobile device transmits one or more control messages to the NAN cluster to change awake patterns and wherein the one or more control messages from the mobile device are carried in an attribute of a NAN service discovery frame.

20. The apparatus of claim 16, wherein a duration between two consecutive awake periods of the second frequency is determined as a function of 16*n TU, where n is one of 1, 2, 4, 8, 16 or 32.

21. The apparatus of claim 16, wherein the one or more indication slots follow a 16*n TU timeslot boundary, where n is 1, 2, 4, 8, 16 or 32.

22. A tangible machine-readable non-transitory storage medium that contains instructions, which when executed by one or more processors of a mobile device in a Neighbor Awareness Networking (NAN) Cluster, result in performing operations comprising:
determine whether to change awake pattern of the mobile device from a first frequency to a second frequency as a function of a number of control messages received at the mobile device;
change the awake pattern of the mobile device to the second frequency, the second frequency having at least one discovery window (DW) and one or more awake periods between two consecutive NAN DWs; and
advertise the second frequency to one or more devices of the NAN cluster;
wherein the awake pattern is changed from the first frequency to the second frequency by inserting one or more indication slots between two consecutive NAN DWs, each indication slot awakening the mobile device at a designated time for an awake period.

23. The medium of claim 22, wherein a duration between two consecutive awake periods is smaller than a duration between two consecutive DWs.

24. The medium of claim 22, wherein the mobile device transmits information during at least one awake period to at least one other device in the NAN cluster to change the awake pattern from the first frequency to the second frequency.

25. The medium of claim 24, wherein the mobile device transmits one or more control messages to the NAN cluster to change awake patterns and wherein the one or more control messages from the mobile device are carried in an attribute of a NAN service discovery frame.

26. The medium of claim 22, wherein a duration between two consecutive awake periods of the second frequency is determined as a function of 16*n TU, where n is one of 1, 2, 4, 8, 16 or 32.

27. The medium of claim 22, wherein the one or more indication slots follow a 16*n TU timeslot boundary, where n is 1, 2, 4, 8, 16 or 32.
